(19) United States
(12) Patent Application Publication
(10) Pub. No.: US 2009/0099964 A1
(43) Pub. Date: Apr. 16, 2009

(54) SYSTEM AND METHOD FOR TRANSFERRING FUNDS TO A BENEFICIARY

(76) Inventor: Efren CALDERON GONZALEZ, Guadalajara (MX)

Correspondence Address: EFREN CALDERON GONZALEZ, LORENZO BARCELATA #4800-B, LOS PINOS, ZAPOPAN, JALISCO 45238, M

(21) Appl. No.: 11/870,297

(22) Filed: Oct. 10, 2007

(51) Int. Cl. G06Q 40/00

(52) U.S. Cl. 705/41; 235/379; 705/36 R; 705/44

(57) ABSTRACT

In a method for transferring funds from a client in one country to a beneficiary in a second country, the client purchases an activation card from a retailer and the retailer sends funds corresponding to the purchase amount to a service provider account at a sending bank. The service provider obtains validation information from the client identifying the card as well as beneficiary identifying information, and confirms the fund transfer to the sending bank. Funds are then sent from the sending bank to a receiving bank in the second country, and placed in an account for the benefit of the beneficiary. The beneficiary is provided with a debit card which can be used to access the funds.

### BACKGROUND

1. Field of the Invention

The present invention relates generally to transferring monetary funds or retail products to a beneficiary in another country or region, and is particularly concerned with fund transfer from a client or purchaser in one country or region to one or more beneficiaries in a second country or region.

2. Related Art

The immigration phenomenon has accelerated growth worldwide in the last decades. It is common for migrants to send money to relatives or friends in their country or region of origin, for birthdays or other special events, or simply to provide support for their family. Latin America is currently the fastest growing market for such money transfers. Currently, there are no particularly secure mechanisms for converting funds in one currency to a second currency and then sending such funds to an individual in an area using the second currency. Sending cash by mail is not secure, and if the cash is lost in the mail, recovery is not possible. Even if funds are sent in the form of an activated, fixed value gift card or the like, there is little or no recourse if the card is lost in the mail or stolen, and there is no guarantee that the card will reach the desired beneficiary. Similar problems arise when gifts or purchased items are mailed from one country or region to a beneficiary or recipient in another country or region.

Therefore, what is needed is a system and method that overcomes these significant problems found in the conventional systems as described above.

### SUMMARY

A system and method for providing funds to a beneficiary in one embodiment allows users in a first country to provide beneficiaries in a second country with a debit card which is then activated by the beneficiary and which can be used to withdraw cash in local currency or make purchases in the second country. In a second embodiment, the system allows users in the first country to make purchases on line which are then provided to beneficiaries at retail establishments in the second country.

A method of providing funds to a beneficiary in one embodiment comprises purchase by a client of an activation card associated with a service provider in a first country, deposit of funds corresponding to the purchase amount into an account of the service provider at a sending bank, receipt of demographic information from the client identifying at least one beneficiary of the funds, storing of the beneficiary information, transferring of deposited funds corresponding to the purchased activation card amount to a receiving bank in a second country, placing the received funds in a bank account at the receiving bank for the benefit of the beneficiary, sending a bank debit card to the beneficiary, receiving validation information from the beneficiary, and activating the bank debit card if the information received matches the stored beneficiary information.

In one embodiment, activation cards of different monetary amounts are provided to one or more retailers, each activation card having a magnetic strip comprising an authorization number, and being associated with a password. After purchase, each card is activated by passing through a point of sale (POS) terminal. A record of the sale of each activated card is provided by the retailer to a service provider (SP), the record comprising the authorization number and the monetary amount. The funds associated with the card are also deposited by the retailer in a sending bank (SB) in the country in which the purchase is made, in a first bank account associated with the service provider.

After purchasing the card, the purchaser communicates with the service provider and provides the password associated with the card along with demographic information on the purchaser and the one or more beneficiaries. Demographic information on the purchaser and beneficiary is then stored along with the identification of the card. The purchaser may also set up a client account in their name for future transfers. Once this procedure is complete, and deposit of funds in the first bank account is confirmed, the SP initiates transfer of funds from the first bank account to a second bank account in a receiving bank (RB) in the country where the beneficiary is located. A bank debit card is then provided to the beneficiary by mail, courier or the like. This card is only activated when the beneficiary provides validation information confirming their identity.

According to another aspect, a money transfer system is provided, which comprises a service provider associated with a plurality of retailers or points of sale and at least one sending bank in a first country, each retailer having a plurality of activation cards each having a magnetic strip carrying data and an activation device for activating the card on purchase by a purchaser. The sending bank is associated with at least one receiving bank in a second country to which funds are to be sent. The sending bank has a first bank account and the receiving bank has a second bank account, and both bank accounts are owned by the same entity. The service provider has a communication module for communication with purchasers of activation cards, in order to obtain information identifying the activation card and demographic information on the purchaser associated with the card and at least one beneficiary to whom funds are to be provided, and a storage module which stores the demographic information identifying the purchaser and the beneficiary in association with information identifying the activation card. A verification module verifies deposit of funds related to the first activation card in the first bank account, and instructs the sending bank to send the corresponding funds to the second bank account to be deposited for the benefit of the beneficiary. The system further comprises a bank debit card associated with the second bank account in the name of the beneficiary, and an activation module for activating the debit card on proof of receipt by the beneficiary corresponding to the stored beneficiary demographic data for the debit card.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a schematic block diagram of a fund transfer system according to a first embodiment;

FIG. 2 is a more detailed block diagram of the service provider of FIG. 1;

FIG. 3 is a schematic block diagram illustrating one embodiment of a network of wholesalers, distributors, retailers, clients and beneficiaries associated with the service provider of FIGS. 1 and 2;

FIGS. 4A and 4B are sequential flow diagrams illustrating one embodiment of a method of transferring funds using the system of FIGS. 1 and 2;

FIG. 5 is a block diagram schematically illustrating the steps in validating an activation card at a point of sale terminal (POS);

FIG. 6 is a schematic block diagram illustrating the fund transfer process when a purchaser has previously registered with the system

FIGS. 7A to 7D are more detailed sequential flow diagrams illustrating the method of arranging for transfer of funds in FIGS. 4A and 4B;

FIG. 8 is a schematic block diagram illustration card activation steps;

FIG. 9 is a schematic block diagram illustrating steps of transferring funds from a sending bank to a receiving bank and activation of a debit card provided to a beneficiary after the fund transfer;

FIG. 10 illustrates more details of the fund transfer process of FIG. 9; and

FIGS. 11A and 11B are sequential portions of a flow diagram illustrating the activation and supply, sale, and authorization process in more detail.

### DETAILED DESCRIPTION

Certain embodiments as disclosed herein provide for method of transferring funds from an individual or client in a first country to a beneficiary in a second country. For example, one method as disclosed herein allows for purchase of an activation card in a desired amount by a client and subsequent delivery of a debit card of the corresponding amount in a foreign currency to a beneficiary.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

In the following description, a network or communication network may refer to a network or combination of networks spanning any geographical area, such as a local area network, wide area network, regional network, national network, virtual private network (VPN), and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others.

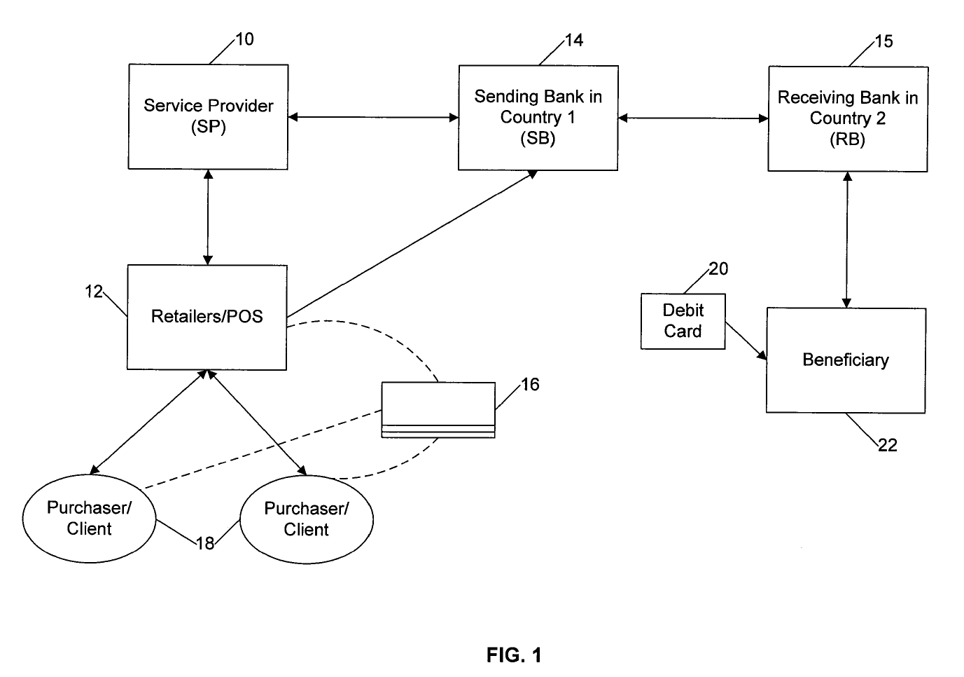

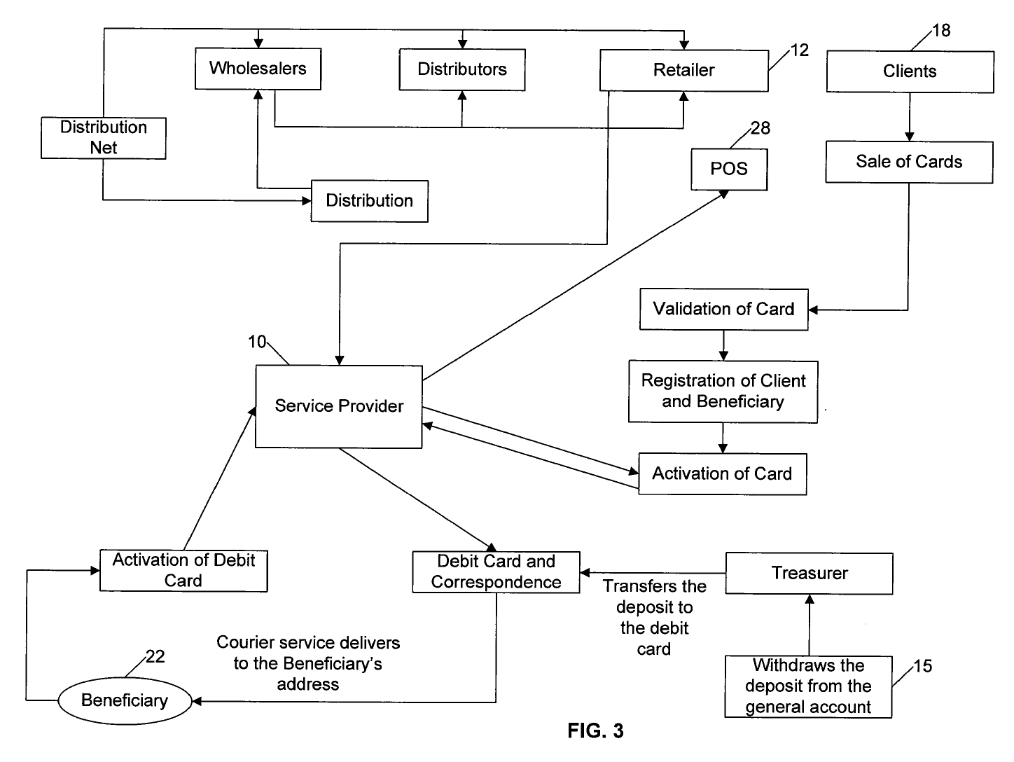

FIG. 1 is a block diagram which schematically illustrates the fund transfer system and method of one embodiment. A service provider (SP) 10 is associated with a plurality of retailers 12 as well as at least one sending bank (SB) 14 in a first country, such as the United States. The SP has a first bank account in its name at the SB 14. The SP is also associated with at least one receiving bank (RB) 15 in a second country, and has a second bank account in its name at the RB. Each retailer 12 sells activation cards 16 to purchasers or clients 18, and has a point of sale (POS) machine for activating purchased cards. The service provider may also be associated with wholesalers who manufacture and supply cards to retailers, and with distributors who arrange for groups of retailers to sell the activation cards (see FIG. 3). The retailers may be stores, restaurants, or any other type of retail establishment. Purchasers or clients 18 contact the service provider to arrange for transfer of funds into debit cards 20 provided to beneficiaries 22 in the second country, which may be a Latin American country such as Mexico.

The service provider 10 in FIG. 1 communicates with retailer POS machines, one or more sending banks, and one or more receiving banks over suitable networks, such as the Internet or other network types as discussed above. SP 10 also communicates with clients and beneficiaries as described in more detail below, and such communications may be via a wired or wireless telephone network, or over other types of network including the Internet.

The activation cards 16 may be provided in different monetary amounts and may have an activation code covered by a scratch off layer, and a magnetic strip containing identifying information which may include a unique card identification number, the card denomination, and an activation code or PIN. The debit cards 20 are standard debit cards of the RB 15. Each card has a magnetic strip which contains the card value, and each card is associated with a PIN number which can only be obtained by a beneficiary when they activate the card after their identity has been verified, as explained in more detail below.

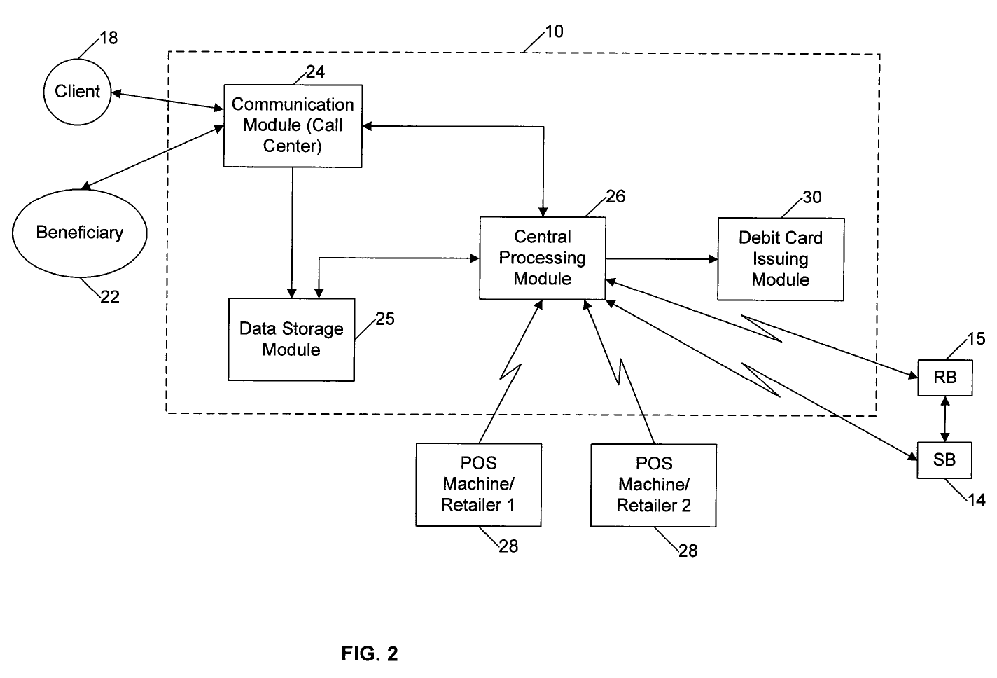

The service provider 10 is illustrated in more detail in FIG. 2. The service provider may have several facilities in the first and second country which are linked via a network such as the Internet, or may be located at a single central location. Service provider 10 has a communication module or call center 24 which controls communications with clients 18 and beneficiaries 22 over a network such as a wired or wireless telephone network, or other wireless networks such as the Internet. A data storage module 25 is connected to the communication module. Central processing module 26 controls operation of the service provider. Module 26 receives data from retailer POS machines 28 on activation card sales, for example via a virtual private network (VPN), and is linked with the SB 14 and RB 15 over a suitable global communication network such as the Internet. A debit card issuing module 30 is linked to the central processing module and issues debit cards to named beneficiaries once fund transfers are verified, as described below. The modules of the service provider in FIG. 2 may comprise a plurality of servers and data bases for performing the various functions described below.

In one embodiment, the Service Provider (“SP”) has arrangements with a US sending bank (“SB”) and a receiving bank (“RB”) located in Mexico, for example to wire funds from users or clients of the service in the US (the “Purchasers”) to Mexican residents (the “Beneficiaries”) who would normally not have access to a checking or savings account. The beneficiaries may be family members of the clients, for example. Once the wired funds reach the SP's account at the RB, bank debit cards are sent to the Beneficiaries via mail, courier service, or the like. The debit cards can be used to withdraw money from Automatic Teller Machines (ATM) anywhere in Mexico or be used to make purchases at establishments that accept electronic debit payments. The cards can only be used in Mexico.

As previously stated, the SP has pre-existing arrangements with the RB to issue bank debit cards in the name of the Beneficiaries. The SP pre-printed bank debit cards contain a magnetic strip. The debit cards have no cash value nor can they be used until they are activated and tied to specific bank accounts at the RB which are opened and held in the name of the SP.

FIG. 3 is a block diagram which schematically illustrates the links between the various entities of the system as described above with the service provider 10, including the distributor and wholesaler network. In the US, the SP sets up a network of wholesalers and distributors that distributes pre-paid “activation” cards in different denominations ($100, $200, $300, $500, and $1,000) and related Point of Service or Point of Sale (POS) machines to retail establishments, such as a Seven/Eleven (the Retailer). The SP deals strictly with the wholesalers, who in turn can recruit up to ten distributors each. The distributors in turn can sign up a maximum of ten Retailers, such that each wholesaler can service up to 100 Retailers. The distributor network is in essence a “sales force,” which provides participating Retailers with packs or bricks of pre-paid “activation” cards, a POS machine, and cash deposit slips from the SB in the name of the SP. The Retailers do not pay for the cards or the POS machine, but rather are paid a commission for each pre-paid activation card that is sold by the Retailer.

FIG. 3 also illustrates the communication links between the purchasers 18, POS machines 28, and beneficiaries 22 in the system of FIGS. 1 and 2 in more detail. In this embodiment, the POS machines are linked to a server at a service provider facility, which validates the card sales and determines the origin of each card and whether the POS machine is associated with the retailer who received that card from the distributor. This server may also determine whether the funds associated with the card purchase have been deposited in the service provider account at the SB, by communicating with the bank and checking deposits into the associated account.

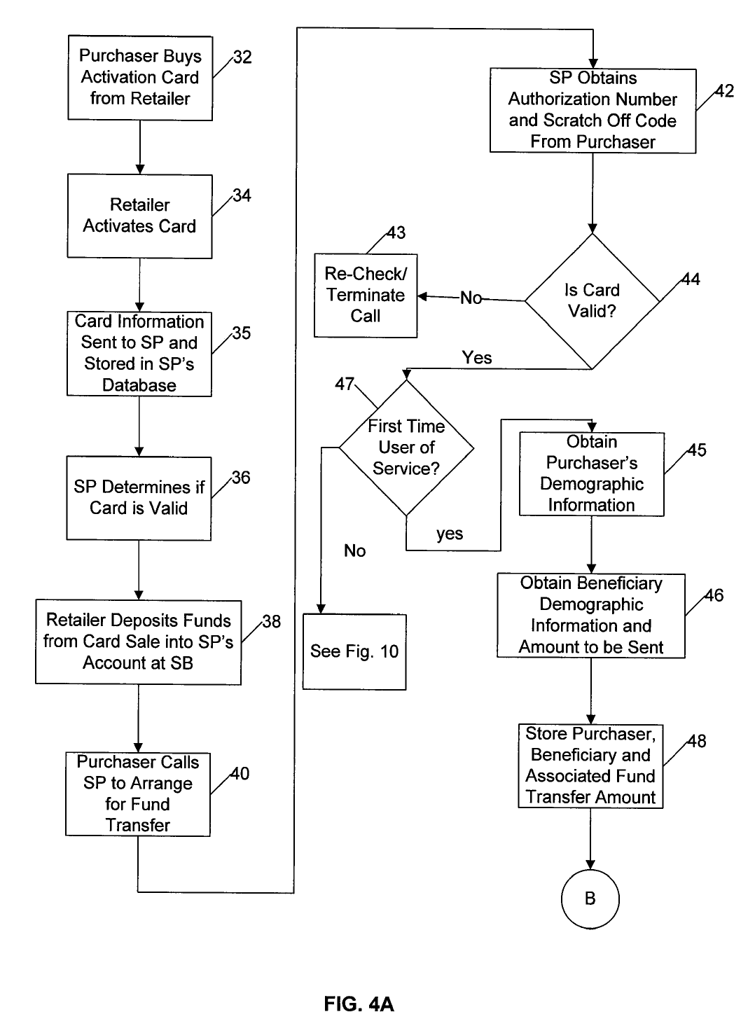

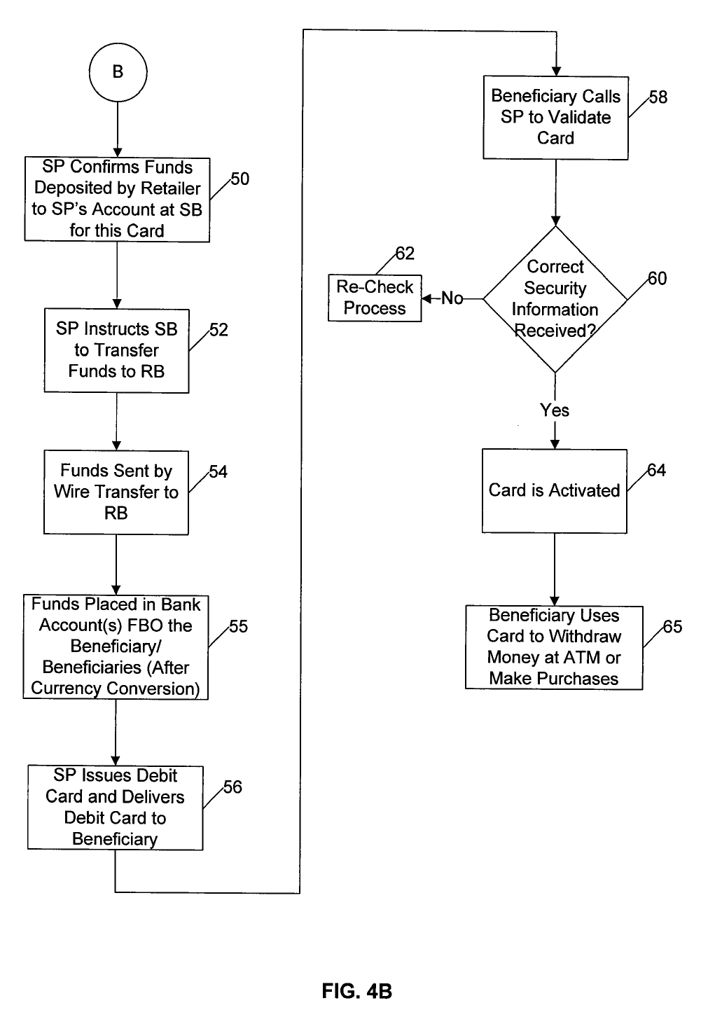

FIGS. 4A and 4B are flow diagrams which schematically illustrate one embodiment of the fund transfer method. When a card is sold at the Retailer (step 32), the Purchaser will pay the face value of the “activation card” plus an additional amount, or commission, for using the service (e.g., a $100 card would cost $110, a $200 card would cost $213, a $300 card would cost $315, a $500 card would cost $517, and a $1,000 card would cost $1,020). In step 34, the retailer accepts the money and swipes the magnetic strip in the activation card through the POS machine 28. This accomplishes several things: 1) it registers with the SP's central processing and call center computers (FIG. 2) that a pre-paid activation card of certain denomination with specific “authorization number” and secret “scratch-off” (alpha-) numeric password has been sold at a specific Retailer/POS (step 35); 2) it allows the SP to “validate” the activation card when the Purchaser later contacts the SP to arrange for the transfer of funds; 3) it allows the SP to later confirm purchase and begin the transfer of funds from the SB to the RB in Mexico; 4) it allows the SP to later activate a corresponding debit card when the funds are received at the RB; 5) it allows the SP to later reconcile POS sales and determine commissions owed to the wholesaler, the distributor, and the Retailer; and 6) it allows the SP to track, in real time, the sales performance of each Retailer/POS.

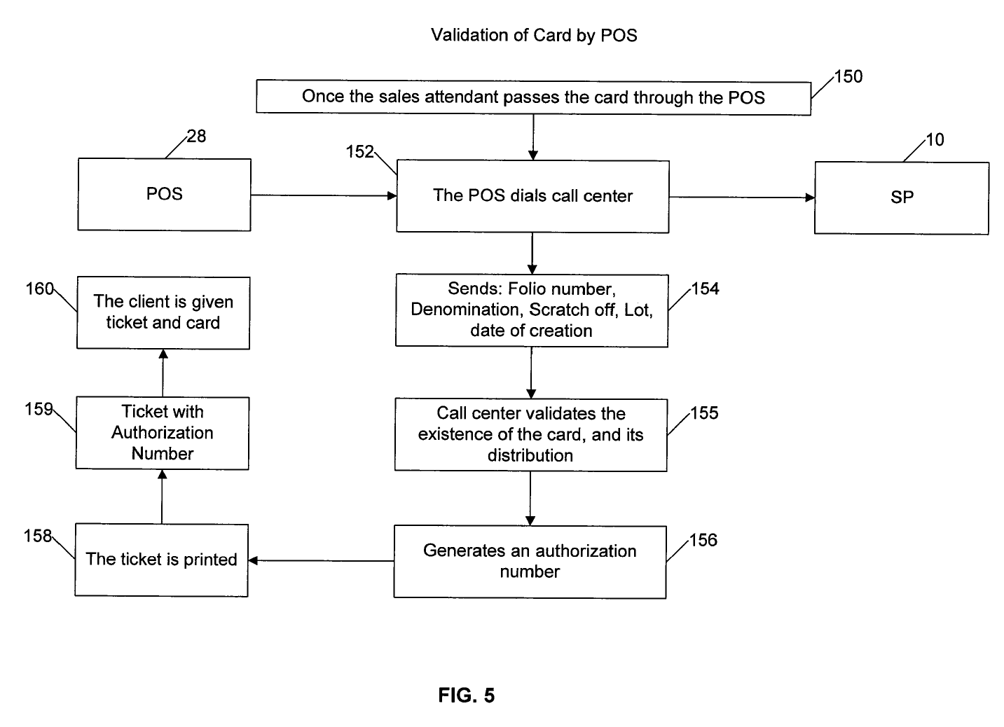

FIG. 5 illustrates the operation of the POS and SP in validating or activating a card 16 in more detail (steps 35 and 36 of FIG. 4A). As illustrated in FIG. 5, when the card is swiped through the POS (150), the POS automatically contacts call center 24 of the SP (152), and sends the information associated with the card (154), along with the denomination or value of the card and the date of sale. The call center in turn validates the existence of the card in step 155 by checking in the data base 25 for card authorization numbers of cards provided to the retailer (i.e. is it a valid card issued by the associated wholesaler to the retailer in question?), and, if the card is found, an authorization number is generated (156). A ticket carrying this number is then printed 158, 159, and both the activation card and the ticket are provided to the purchaser 160.

Referring again to FIG. 4A, at the end of each day, the Retailer uses the SP's Deposit Slip to deposit all revenues from the sale of pre-printed activation cards (including commissions paid by the Purchaser) into the SP account at the SB (step 38).

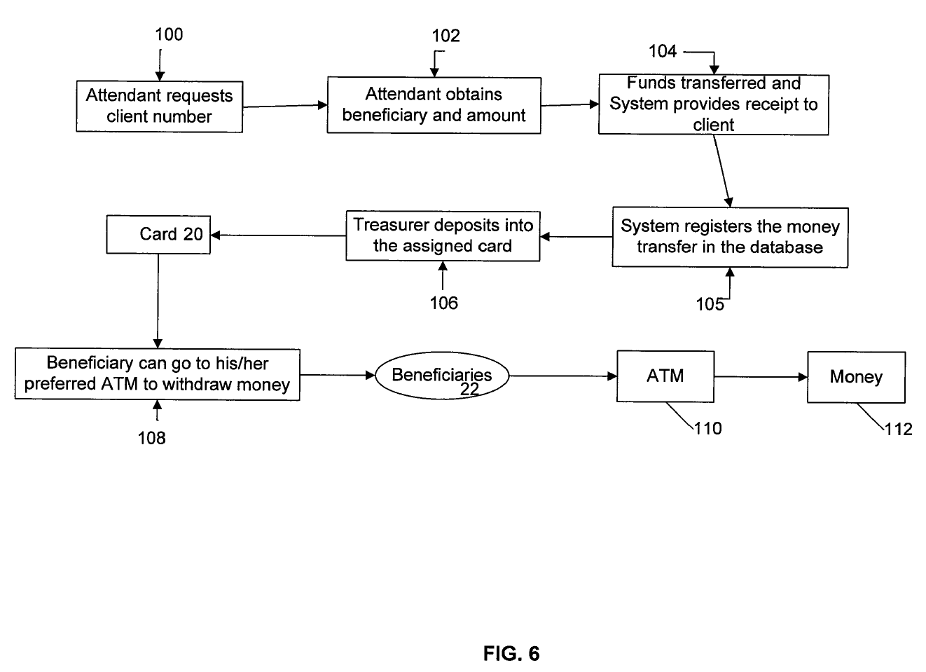

Once a pre-paid activation card is validated by the SP, the Purchaser can call a live operator or access an Interactive Voice Response (IVR) telephone system at the SP's call center to arrange for the transfer of funds up and including the amount of the card's denomination (step 40). In step 42 the operator or IVR at the SP call center asks the caller for the activation card's number (i.e. the authorization number on the ticket) and the “scratch-off” password in order to “validate” the card (step 44). The validation or card verification process at the SP may include verification that the card exists, that the card was sold, and that the wholesaler, distributor, and point of sale for that card are correct. If the SP is unable to validate the card, i.e. it does not match information received from the retailer at step 35, additional steps are taken, such as asking the caller to re-enter the information (43). If the card is still not validated after a predetermined number of attempts, the call may be ended or the call center may transfer the caller to a supervisor to take additional steps. If the information entered by the caller matches information in the data base, an operator determines whether this is the first time that the caller has used the service (step 47). If not, the operator or IVR asks the caller for their client ID and then proceeds to obtain beneficiary information for the card funds from the caller. The simplified procedure for processing fund transfers for previously registered users of the system is illustrated in FIG. 6 and described below. If it is the first time that this purchaser has used the system, the operator or IVR asks the caller to provide demographic information (step 45) which may include some or all of the following: 1) full name, 2) date of birth, 3) occupation, 4) SS number, 5) type of identification (driver's license or other type of ID), 6) ID number, 7) US address, and 8) telephone number. If this is the first time that this purchaser has used the system, the call center assigns a client number to the purchaser which is associated with the demographic information collected and stored in the data base. This number may be the client's telephone number, for example. The client number can then be used to expedite the transfer procedure when future activation cards are purchased, as described in more detail below in connection with FIG. 6.

The operator then asks for information about the Beneficiary(ies), including: 1) full name, 2) relationship to Purchaser, 3) Mexican address, 4) telephone number, 5) e-mail address, 6) State, 7) city, and 8) colony (step 46). The purchaser confirms how much cash is to be sent to the beneficiary or how much cash each of the beneficiaries is to receive if multiple beneficiaries are involved. The purchaser is informed of a one time set-up fee ($15) for each beneficiary, and that accounts at the RB can be created for up to five beneficiaries. The activation card can then be discarded. After all names are obtained, a compliance procedure of the SP is used to check the purchaser and beneficiary names against the Office of Foreign Assets Control (OFAC) list, using commercially available software. If any purchaser or beneficiary name appears on the list, the service provider notifies OFAC authorities. The same procedure also checks to make sure that amounts over $3000 are not sent or received by the same person. If amounts over $3000 are detected, an investigation is carried out.

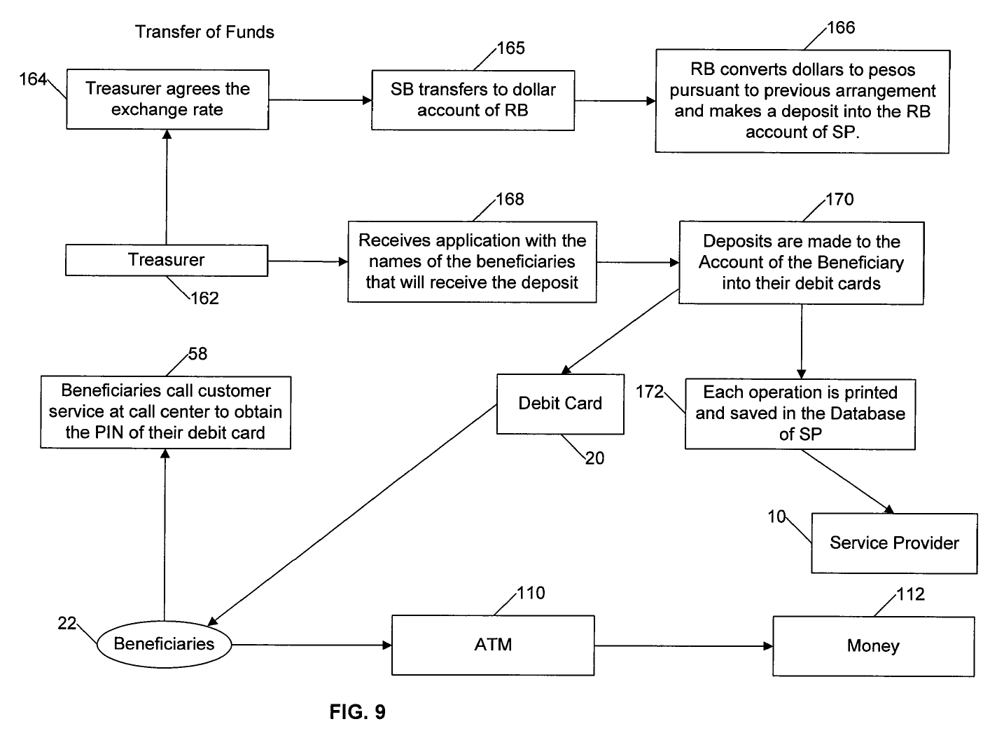

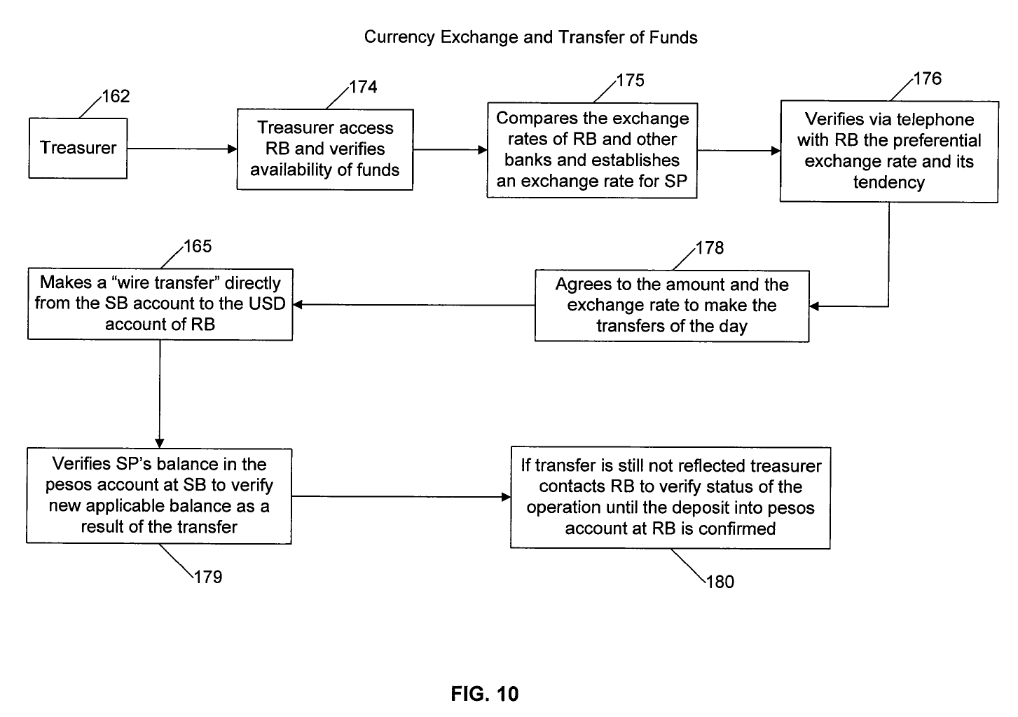

The purchaser, beneficiary, and transfer amount data is saved in the SP's data base at the processing center (step 48). As illustrated in FIG. 4B, once the SP verifies that the Retailer deposited the corresponding funds at the SB (step 50), the SP will initiate the transfer of funds from the SB to the RB (step 52). If transfer cannot be verified, the POS is contacted for clarification. If receipt of funds is verified, the funds are sent to the RB via wire transfer (step 54) through any one of the existing bank transfer systems (e.g., SWIFT) and placed in individual bank accounts for the benefit of (“FBO”) each beneficiary (step 55). The accounts and related bank debit cards are owned by the SP. Each Beneficiary account cannot exceed $3,000. Conversion is made from US currency to Mexican currency prior to placing funds into the or each beneficiary account, as illustrated in FIGS. 9 and 10, as described in more detail below.

Once the funds are received at the RB, the SP delivers a bank debit card and a welcome/instruction letter by messenger, courier, mail or the like to the intended beneficiary (step 56 of FIG. 4B). The beneficiary acknowledges delivery by signing for the card. The letter instructs the beneficiary to call the SP's call center to activate the card. When the beneficiary calls (step 58), the operator asks for certain information (such as the beneficiary name and address, the bank debit card number, the name of the person sending the funds, his address, etc.) for security reasons to confirm that the caller is the intended beneficiary (step 60). If the system is unable to validate the caller as the correct beneficiary, additional steps (62) may be taken to try and validate the caller's identity. If these are not successful, the call is terminated and the card is identified as possibly stolen.

If the security information received from the caller matches the stored beneficiary information associated with the original purchaser in the system data base, the card is activated and the beneficiary is provided with the PIN number associated with the card (step 64). Once the card is activated, the beneficiary can use it to withdraw cash at any compatible ATM or use it to pay for purchases at retailers equipped with POS machines (step 65), as illustrated in FIG. 9.

Once a purchaser account and related beneficiary account(s) are established, a Purchaser can purchase additional pre-paid activation cards in the US to send money to each of his beneficiaries in Mexico by accessing a streamlined version of the IVR calling system or identifying himself to the live operator as an existing purchaser. FIG. 6 illustrates the procedure carried out when an existing client purchases another activation card and calls the service provider to arrange for more funds to be transferred to a previously arranged beneficiary. Once the client number is provided (step 100 of FIG. 6) and the activation card information received from the client matches the information stored in the service provider's data base, the client is prompted to select one or more beneficiaries and the amount or amounts to be transferred (102). If demographic information on the selected beneficiary has already been provided, and the fund transfer from the POS/retailer to the sending bank is confirmed, the service provider can instruct the SB to transfer funds to the receiving bank (104), where they can be placed in the account already established in the name of that beneficiary (106) and assigned to the same debit card 20 that was previously provided to the beneficiary. The beneficiary uses the same debit card which was originally provided to access those funds (108) and obtain cash.

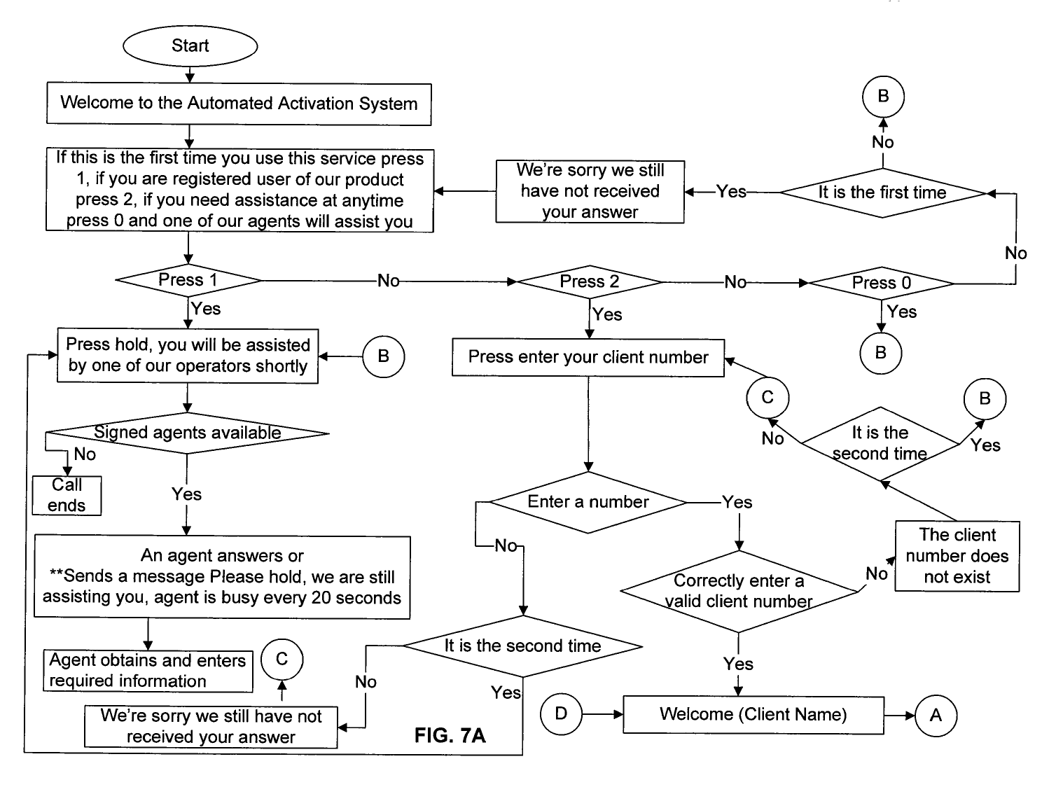

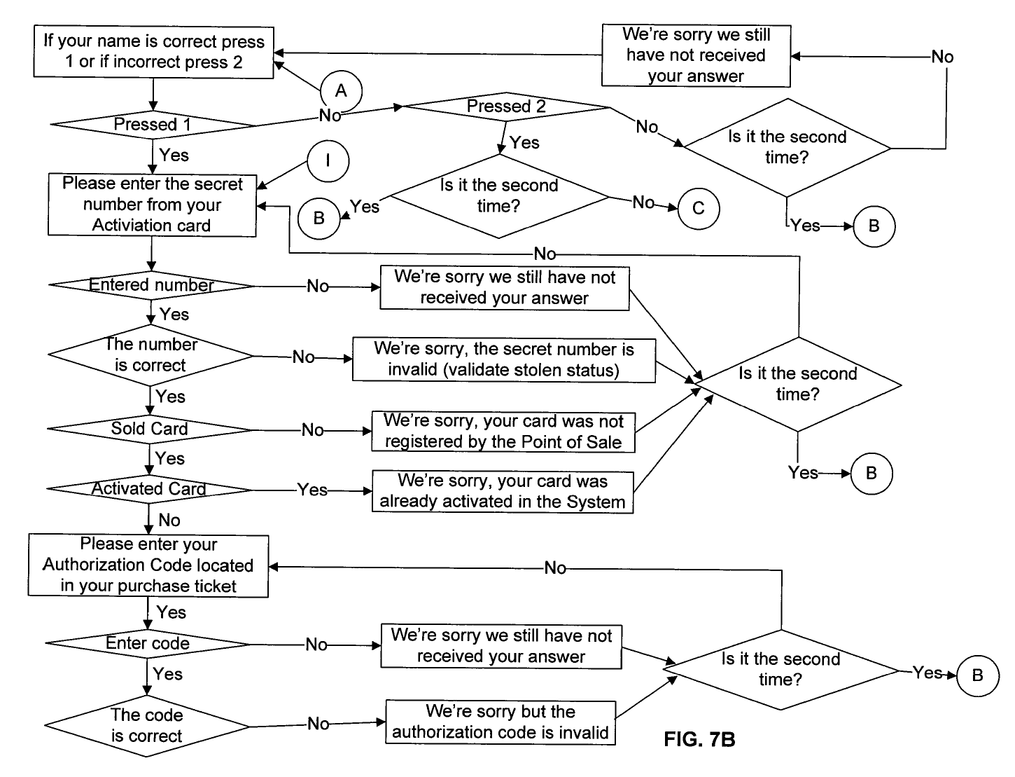

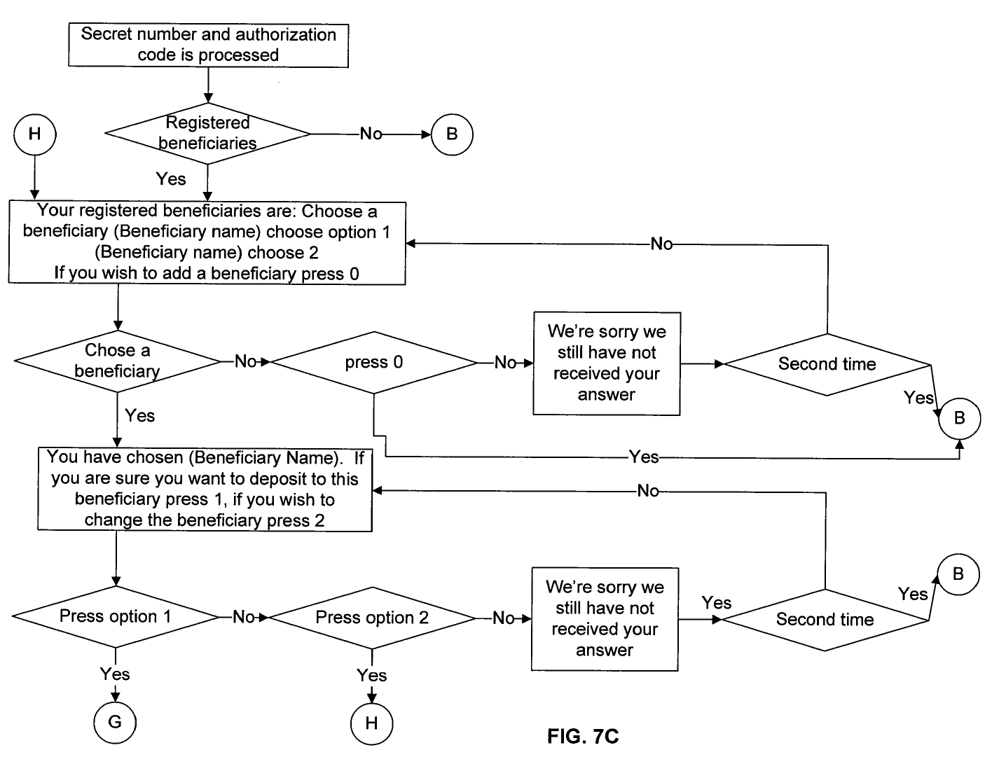

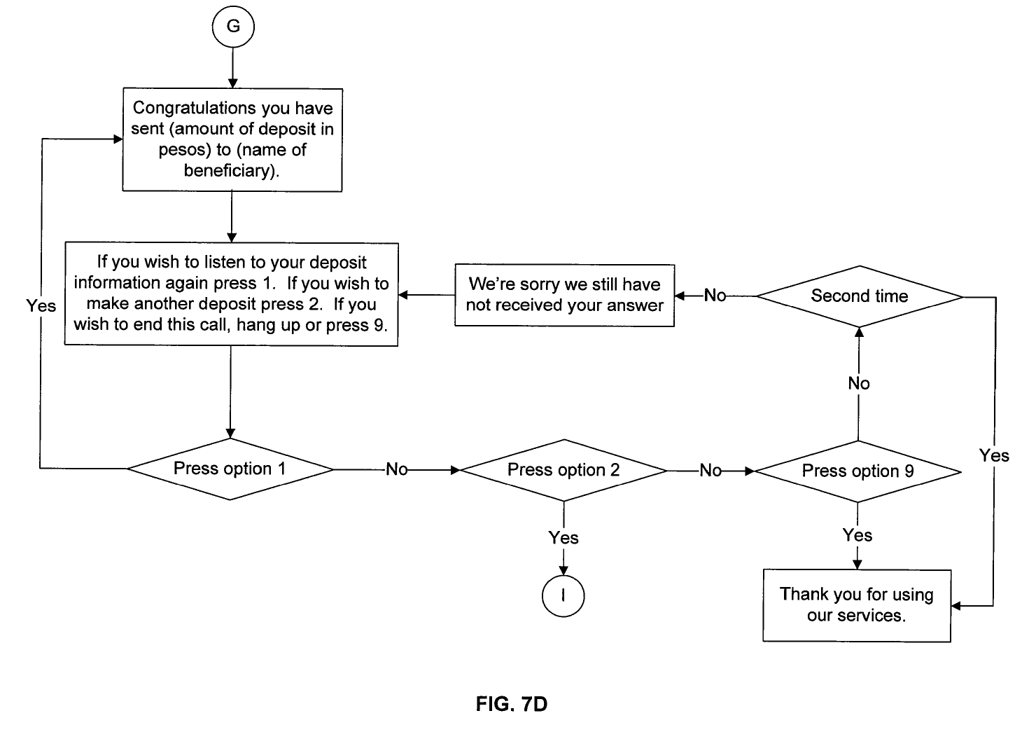

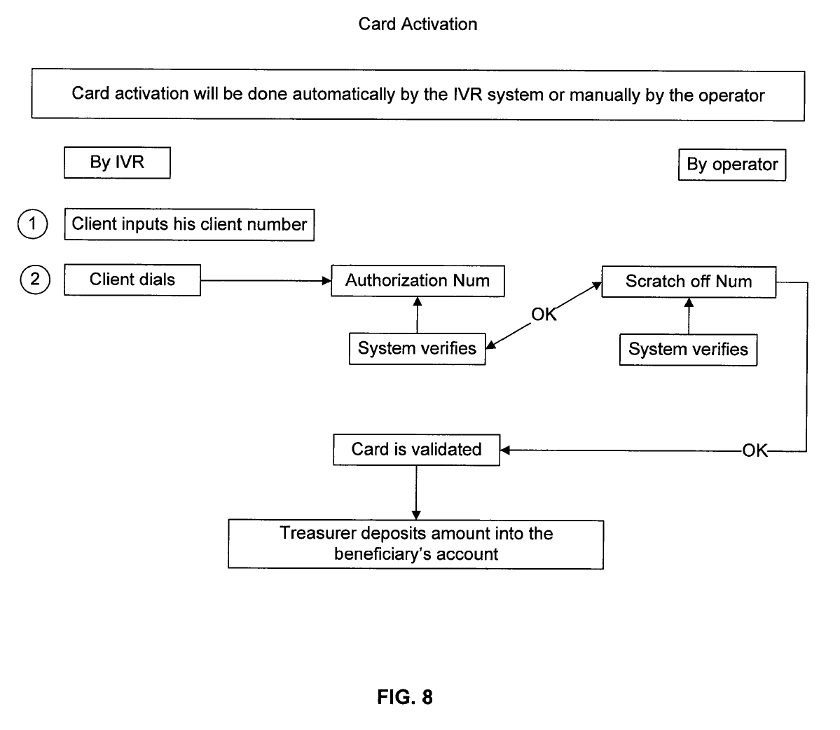

FIGS. 7A to 7D illustrate the interaction between the call center and the purchaser after purchase of an activation card (steps 40 to 48 of FIG. 4A) when an IVR system is used in more detail. Although these steps in the illustrated embodiment involve interaction between the purchaser or client and an IVR system, the purchaser may alternatively contact the call center using a personal computer over the Internet. In this case, the call center has a secure website at which the purchaser can sign on and provide the same information as illustrated in FIGS. 4 and 7. In this case, the questions in FIGS. 7A to 7D will appear in an interactive response screen at the user's terminal.

As illustrated in FIG. 7A, the IVR system first asks the caller to select between options according to whether they are a first time user of the system or not. If they are a first time user, they are directed to a human operator who will obtain the necessary information to set them up as a client of the system. They can be returned to the IVR system once the beneficiary information is obtained and a client number assigned, or the entire procedure may be carried out with a human operator. Also, at any time during interaction with the IVR system, the caller may be directed to an operator, either at their request or if the necessary information at any step is not entered by the user or does not correspond to stored information, as indicated by option B throughout the flow diagram of FIGS. 7A to 7D. Typically, the caller is allowed two attempts to enter the correct information before being directed to the operator. FIG. 7D illustrates the end of the client or purchaser interaction with the IVR system, in which confirmation is provided that they have sent the requested amount to the beneficiary. The system then proceeds to step 52 of FIG. 4B in order to complete the fund transfer.

FIG. 9 illustrates more details of the steps 52 to 56 in which fund transfer takes place between the sending and receiving banks. Once the treasurer 162 agrees on the exchange rate (164), the sending bank SB transfers the funds to the dollar account at the receiving bank RB (step 165), and the receiving bank converts the dollar amount into the local currency (such as pesos when the receiving bank is located in Mexico, for example) and deposits the amount into the bank account (step 166).

The treasurer also receives the names of the beneficiaries who will receive the deposit (168), and deposits are made in the appropriate amounts for the benefit of the beneficiaries (170) which can subsequently be withdrawn by beneficiaries using their debit card. Beneficiaries call customer service at the service provider to obtain the PIN number of the debit card, as in step 58 of FIG. 4B. Each operation is printed and saved in the data base of the service provider SP (172).

FIG. 10 illustrates more detail of the currency exchange and fund transfer process in one embodiment. The treasurer 162 accesses the receiving bank in order to verify availability of funds (174), and compares the exchange rate of the receiving bank with that of other banks (175) in order to establish an exchange rate for the service provider. This preferred exchange rate may be verified by telephone (176) on a daily basis as required. Once the amount and the exchange rate for the day are agreed (178), a wire transfer is made directly from the SB account to the dollar account of the SP at the RB (165). The conversion to pesos is made at the agreed upon exchange rate and the amount in pesos is deposited into the peso account of the SP at the RB, as in step 166 of FIG. 9. The treasurer then verifies the balance in the peso account to verify the new balance as a result of the transfer (179). If the transfer is not reflected by the balance in the peso account, the treasurer contacts the RB to verify the status, and this is repeated as necessary until the deposit is confirmed (180).

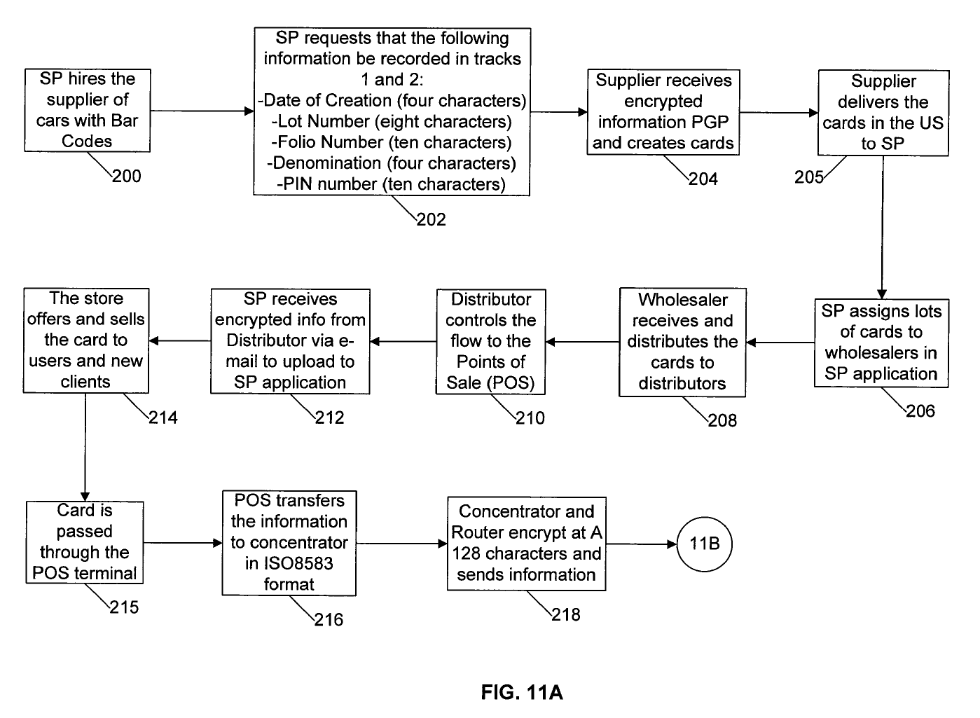

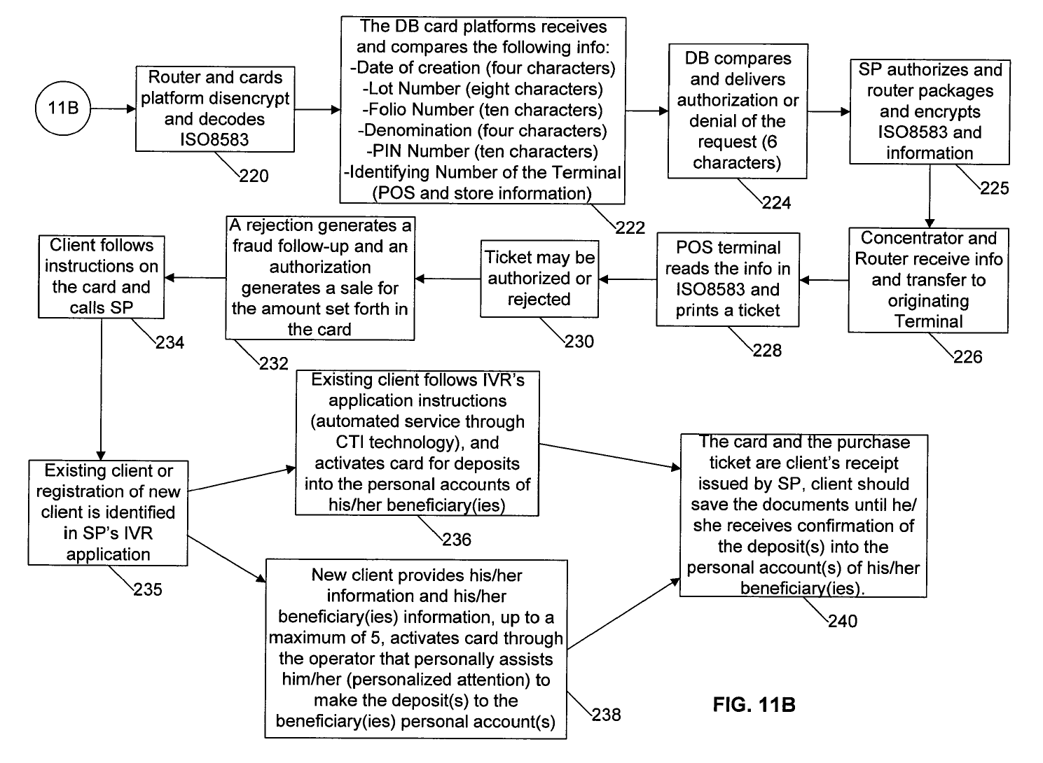

FIGS. 11A and 11B illustrate details of one embodiment of the initial set up of activation cards with distributors and the subsequent sale and card authorization procedure. In step 200, the service provider (SP) hires a supplier to supply cards with bar codes and optionally also a scratch off area as described above. The SP requests that the following information is recorded in the bar code of each card (202):
Date: Date of creation for internal control
Lot Number Product identification
Folio Number: Is the identification folio of the Card
Denomination: 100, 200, 300, 500 and 1000 Dollars
PIN number: Unique authorization number for card.
   The information may be provided to the supplier in encrypted text such as PGP and the supplier creates the cards (204). The cards are delivered to the SP (205), and the SP assigns lots or batches of cards to wholesalers (206). The wholesalers then distribute the cards to distributors (208), who in turn control the flow or supply of cards to the points of sale POS (210). Encrypted information is provided to the SP identifying which POS is associated with each batch of cards, and this information is stored in the SP's data base for later matching with purchased cards (212).

The various stores with POS terminals offer and sell cards to existing and new clients (214). Each purchased card is passed through the POS terminal at the store (215), and the POS terminal transfers the information to a concentrator in International Standards Organization (ISO) 8583 format (216). The information is then encrypted and sent via a router to the SP site (218). The server at the SP decrypts the information and decodes the ISO8583 (220). The decrypted and decoded information is then compared to the information stored in the data base at the SP (222). The following information is compared in this step:

Date of Creation (Four characters)
Lot Number (Eight characters)
Folio Number (Ten characters)
Denomination (Four characters)
PIN number (Ten characters)
Identifying number of the Terminal (POS and store information).
The information identified through the bar code may also comprise the type of card (fund transfer activation card). The types of establishment selling the cards may include restaurants, stores, supermarkets, and the like.

The information stored in the data base and the decrypted and decoded information is compared and the request is denied or authorized depending on whether there is a match (224). If there is a match, fund transfer is authorized and the authorization information is coded in ISO8583 and encrypted (225) and then transferred to the originating POS terminal (226). The POS terminal reads the information in ISO 8583 and prints the ticket (228). The ticket may indicate that the sale is authorized or rejected (230). A rejection generates a fraud follow up and an authorization generates a sale for the amount set forth on the card (232). The card and ticket are given to the client, who follows the instructions on the card and calls the service provider phone number provided on the card (234). The steps carried out during interaction between the client and service provider at this stage are illustrated in detail in FIGS. 7A to 7D. Briefly, the SP determines whether the client is an existing client or is a new client (235). If it is an existing client, the client follows the IVR application instructions in order to activate the card for deposits into the personal accounts for the benefit of the client's selected beneficiaries (236). If the client is new, the new client provides beneficiary information and activates the card through an operator who assists him or her personally to make the initial deposits (238), as illustrated in more detail in FIGS. 7A to 7D.

For both new clients and existing clients, the card and the purchase ticket are the client's receipt issued by the SP, which may be saved until the client receives confirmation that the beneficiary has received the funds via the debit card which was provided in the case of a new client or via the previously received debit card in the case of an existing client (240). In the process of FIGS. 1A and 1B, the POS communicates with the service provider SP site, identifying itself as a registered establishment. This verification takes place each time the Point of Sale (POS) communicates with the secure SP site. On receipt of the unique card identifying information, the system determines if the sales operation is correct. If correct, the sale is authorized by the issuance of a sales code or authorization code.

The process is completed when the client makes his/her telephone call to the SP, and registers as a client and also registers his/her beneficiaries in Mexico or other countries. The information provided by the client is validated in the system for subsequent purchases and other purposes, as well as to comply with the procedures required by law regarding the OFAC (Office of Foreign Control Assets) lists and credit history.

Once the registration of the client is complete, the system asks for the authorization number set forth in the purchase ticket, as well as the scratch number from the card itself. This information completes the activation process of the card and automatically activates the disbursement of funds to the client's beneficiaries in Mexico via RB debit cards provided to the beneficiaries.

The system and method described above may further include a report generating module which tracks sales of activation cards and also maintains the client data base. There is also a procedure for replacing lost or stolen debit cards.

In the above embodiment, funds are transferred from an individual in one country to a recipient in another country. In an alternative embodiment, a product registry is used to enable a purchaser to select products to be provided to a designated beneficiary at a store in a different country. Such purchases may be made online at a website including a product catalog, or a catalog may be sent to purchasers of the activation card. In this embodiment, the purchaser uses the card to buy products from the catalog to be picked up by a recipient in another country. Once the purchase is made, the recipient or beneficiary is notified and can pick up the product from a retail outlet in another country, such as Mexico. In this case, the service provider organizes the remittance to the retailer, which may be a retailer having outlets in both the purchaser's and the beneficiary's country of residence.

Those of skill in the art will appreciate that the various illustrative logical blocks, modules, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium or data base including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for providing funds to a beneficiary, comprising:
providing a plurality of activation cards to one or more retailers, each activation card having a magnetic strip comprising an authorization number, each activation card also having a password;
receiving via a first communication after the sale of a first activation card a record of the sale of the first activation card, the record comprising the authorization number for the first activation card and the monetary amount of the first activation card;
receiving via a second communication after the sale of the first activation card the password from the first activation card; demographic information about the purchaser of the first activation card, and demographic information about the beneficiary of the first activation card;
storing the demographic information about the purchaser and the beneficiary in association with information about the first activation card;
verifying the deposit of funds related to the first activation card in a first bank account;
initiating the movement of funds from the first bank account to a second bank account, where the first bank account and the second bank account are owned by the same entity;
identifying the beneficiary of the first activation card as the beneficiary of the second bank account;
sending a bank debit card to the beneficiary;
receiving via a third communication after sending the bank debit card to the beneficiary, information validating the recipient of the bank debit card as the beneficiary; and
activating the bank debit card for use with the second account.

2. The method of claim 1, wherein the first and second bank accounts are in first and second countries and the step of moving funds from the first bank account to the second bank account includes converting the funds from a first currency of the first country to a second currency of the second country before depositing the converted funds into the second bank account.

3. The method of claim 1, wherein the beneficiary information received and stored via the second communication comprises information on a plurality of beneficiaries along with selected monetary amounts for each beneficiary up to the monetary amount of the first activation card, the step of moving funds from the first bank account to the second bank account further comprises depositing each selected monetary amount in the second bank account for the benefit of the beneficiary associated with the respective selected monetary amount, the step of sending a bank debit card comprises sending bank debit cards to each beneficiary, the step of receiving via a third communication comprising receiving via a plurality of third communications information validating each recipient of a bank debit card as a valid beneficiary, and the step of activating comprising activating each bank debit card for use with the second bank account on receipt of the associated valid beneficiary information.

4. The method of claim 1, further comprising receiving via the second communication information for registering the purchaser for subsequent activation card purchases, storing client registration information along with a client identifier and beneficiary information for the registered purchaser, and providing the purchaser with the client identifier for subsequent fund transfers.

5. The method of claim 4, further comprising receiving a record of the sale of a second activation card by a previously registered purchaser, depositing funds associated with the registered client purchase into the first account at the first bank in the amount associated with the second activation card, receiving the client identifier and second activation card identifier from the registered client, initiating the movement of deposited funds corresponding to the purchased second activation card value to the second bank account, and activating the debit card previously provided to the selected beneficiary for access to the deposited funds associated with the second activation card purchase.

6. A fund transfer service provider for controlling transfer of funds to a beneficiary, comprising:
a first communication module associated with at least one retailer which receives records of sales of activation cards from the retailer, each record comprising the authorization number and the monetary amount of the respective activation card;
a storage module which stores records of activation card sales;
a second communication module which communicates with activation card purchasers to obtain a password associated with each purchased activation card, demographic information about the purchaser of the purchased activation card, and demographic information about the beneficiary of the purchased activation card;
the storage module storing the demographic information about the purchaser and beneficiary in association with the record of each activation card sale;
a verification module which verifies deposit of funds associated with each activation card sale in a first bank account;
a fund transfer module which initiates transfer of funds associated with each activation card sale from the first bank account to a second bank account on receipt of the demographic information on the purchaser and beneficiary associated with the activation card sale and verification of the deposit of the associated funds in the first bank account, each fund transfer identifying the beneficiary associated with the respective activation card sale in the storage module as the beneficiary of the associated funds transferred to the second bank account;
a debit card sending module which initiates sending of a bank debit card to the beneficiary associated with each verified activation card sale and associated fund deposit;
a third communication module which communicates with a recipient of a bank debit card and receives information validating the recipient as the beneficiary associated with the verified activation card sale; and
an activation module which activates each debit card on validation of the recipient of the respective debit card as the beneficiary associated with the verified activation card sale associated with the respective debit card.

7. The service provider of claim 6, wherein the first bank account is located in a first country and the second bank account is located in a second country.

8. The service provider of claim 7, wherein the fund transfer module further initiates conversion of the funds into a second currency of the second country before deposit of the funds into the second bank account.

9. A method of providing funds to a beneficiary, comprising:
receiving confirmation of purchase by a client in one country of an activation card associated with a service provider, the activation card having a selected monetary value;
depositing funds corresponding to the monetary value of the activation card into a first account of the service provider at a sending bank;
receiving demographic information from the client identifying at least one beneficiary of the funds and selecting a monetary amount to be transferred to the beneficiary up to the monetary value of the activation card;
storing the beneficiary information;
transferring of deposited funds corresponding to the purchased activation card value to a receiving bank in a second country;
placing the received funds in a second bank account of the service provider at the receiving bank;
sending a bank debit card of the receiving bank to the beneficiary;
receiving validation information from the beneficiary; and
activating the bank debit card if the validation information received matches the stored beneficiary information, whereby the beneficiary can obtain funds up to the monetary amount selected by the client.

10. The method of claim 9, further comprising the step of obtaining and storing demographic information for at least first and second beneficiaries, and obtaining and storing a monetary amount to be transferred to each beneficiary, the step of placing received funds in the second bank account comprising placing a first monetary amount in the second bank account for the benefit of the first beneficiary and placing a second monetary amount in the second bank account for the benefit of the second beneficiary, and the step of sending a bank debit card comprising sending a first bank debit card in the first monetary amount to the first beneficiary and sending a second bank debit card in the second monetary amount to the second beneficiary.

11. The method of claim 10, comprising obtaining and storing demographic information on a plurality of beneficiaries, and obtaining and storing a monetary amount associated with each beneficiary, receiving and storing funds in the second bank account for the benefit of each beneficiary in the associated monetary amount for that beneficiary, and sending bank debit cards in the associated amounts to the respective beneficiaries.

12. A method for providing products to a beneficiary, comprising:
providing a plurality of activation cards to one or more retailers in a first geographic region, each activation card having a magnetic strip comprising an authorization number, each activation card also having a password;
receiving via a first communication after the sale of a first activation card a record of the sale of the first activation card, the record comprising the authorization number for the first activation card and the monetary amount of the first activation card;
receiving via a second communication after the sale of the first activation card the password from the first activation card, demographic information about the purchaser of the first activation card, demographic information about the beneficiary of the first activation card, and product purchase information about at least one product to be purchased using the monetary amount of the first activation card;
storing the demographic information about the purchaser and the beneficiary along with the selected product information in association with information about the first activation card;
verifying the deposit of funds related to the first activation card in a first bank account;
initiating the movement of funds from the first bank account to a retail outlet in a second geographic region local to the beneficiary and remote from the first geographic region;
using the funds to purchase the selected product at the retail outlet for the benefit of the beneficiary; and
sending notification of the purchased product to the beneficiary, whereby the beneficiary can pick up the purchased product at the retail outlet.
